(19) United States
(12) Patent Application Publication
(10) Pub. No.: US 2018/0303695 A1
(43) Pub. Date: Oct. 25, 2018

(54) VIRTUAL REALITY-BASED REHABILITATION

(71) Applicant: Neurobotics LLC, Whitestone, NY (US)

(72) Inventor: Salvatore Loduca, Great Neck, NY (US)

(73) Assignee: Neurobotics LLC, Whitestone, NY (US)

(21) Appl. No.: 15/495,165

(22) Filed: Apr. 24, 2017

(51) Int. Cl. A61H 1/02

(52) U.S. Cl. CPC A61H 1/0237; G06T 19/006; A61H 2201/5043; A61H 1/0274

(57) ABSTRACT

A method of performing rehabilitation includes moving a first limb of a patient and displaying, for viewing by the patient in virtual reality, the movement of the first limb of the patient as the first limb of the patient is being moved.

### BACKGROUND

### Technical Field

The present disclosure relates to rehabilitation, and more particularly, to the use of virtual and augmented reality technologies in rehabilitation procedures.

### Description of Related Art

For over a century the scientific literature is replete with studies involving contralateral or bi-lateral transfer principles for sports training and medical rehab. The bilateral transfer approach to training and rehab is the process whereby the training of one limb gives rise to enhancements in the performance of the opposite, untrained limb.

The contextual interferences effect is a learning phenomenon where interference/distraction during practice, or rather “fully randomized” practice, enhances skill learning. That is, higher levels of contextual interference lead to poorer practice performance than lower levels while yielding superior retention and transfer performance. This rather counterintuitive effect, first demonstrated by Battig for verbal materials and later shown to be relevant to motor skill learning by Shea and Morgan, has led to a considerable amount of research in the past half-century.

While contralateral (i.e., bilateral) transfer principles are typically more of a short term transfer process, contextual interference is typically a longer term learning process from a cognitive and motor muscular view point. Up until now, these two principles, namely bilateral transfer and contextual interference, have yet to be combined for testing in the laboratory or applied to sport-specific training, strength and conditioning or in the physical and cognitive medical setting.

Virtual reality (VR) is an artificial, computer-generated simulation or recreation of a real life environment or situation. Augmented reality (AR) is a technology that layers computer-generated enhancements atop an existing reality in order to make existing reality more meaningful through the ability to interact with it. Virtual reality allows a user to immerse oneself in a simulated environment experienced by the user as being real while being able to avoid any limitations or pitfalls that physical reality may present.

Given the beneficial cross-over effects that contra-lateral and bilateral principles provide in rehab, and the unique experience of reality provided by VR and AR technologies, it would be advantageous to provide a method of rehabilitating a patient by opening unused neural pathways in the brain through a safe, natural, and organic process without requiring a patient to unduly exert themselves or perform physical tasks that their injury or physical limitations may not permit. Utilizing, in tandem, both bilateral transfer and contextual interference principles that can now be embedded in emerging VR and AR technologies provides the means to “rewire” the brain or “open and activate” dormant sensor-neuro-motor muscular pathways.

### SUMMARY

In one aspect of the present disclosure, a method of performing rehabilitation is provided and includes moving a first limb of a patient, and displaying, for viewing by the patient in virtual reality, the movement of the first limb of the patient as the first limb of the patient is being moved.

In some methods, the first limb of the patient may be moved involuntarily.

Some methods may further include moving a second limb of the patient concurrently with movement of the first limb. The method may further include displaying, for viewing by the patient in virtual reality, the movement of the second limb of the patient.

In some methods, the first and second limbs may be moved in a different direction and/or a different speed relative to one another.

In some methods, the first and second limbs may be movable in a different direction and a different speed relative to one another.

Some methods may further include recording the virtually displayed movement of the first limb, and displaying, for viewing by the patient in virtual reality, the recorded virtually displayed movement of the first limb. The recorded virtually displayed movement of the first limb may be displayed while the patient attempts to voluntarily move the first limb. The patient may attempt to voluntarily move the first limb along a path and at a speed each matching the path and the speed of the virtually displayed movement of the first limb.

Some methods may further include recording the virtually displayed movement of the first limb, and displaying, for viewing by the patient in augmented virtual reality, the recorded virtually displayed movement of the first limb.

Some methods may further include inserting the first limb and a second limb of the patient into a respective fastening member of a robotic rehabilitation apparatus. Each fastening member may be operably coupled to a respective robotic arm of a plurality of robotic arms of the robotic rehabilitation apparatus. The method may further include actuating the plurality of robotic arms to effect movement of the first and second limbs. The first and second limbs may be moved in a different direction and/or a different speed relative to one another.

In some methods, the first and second limbs may be moved in a different direction and a different speed relative to one another.

Some methods may further include positioning the patient on a table of the robotic rehabilitation apparatus. The robotic rehabilitation apparatus may include a control device operably connected to the plurality of robotic arms for directing a selected movement of the plurality of robotic arms.

In another aspect of the present disclosure, another method of performing rehabilitation is provided and includes moving a first limb of a plurality of limbs of a patient while immobilizing a second limb of the plurality of limbs of the patient. Movement of the first limb and the immobilized second limb of the patient is displayed for viewing by the patient in virtual reality.

Further details, advantages, and aspects of exemplary embodiments of the present disclosure are described in more detail below with reference to the appended figures.

As used herein, the terms parallel and perpendicular are understood to include relative configurations that are substantially parallel and substantially perpendicular up to about + or −10 degrees from true parallel and true perpendicular.

As used herein, the term “limb” is defined to include an arm, a leg, a foot, a hand, a finger, a toe, a neck, or a portion of any one of the above.

### BRIEF DESCRIPTION OF THE DRAWINGS

Embodiments of the present disclosure are described herein with reference to the accompanying drawings, wherein:

FIG. 1 is a perspective view of a rehabilitation apparatus used with a VR headset in accordance with the principles of the present disclosure;

FIG. 2 is a perspective view of a patient wearing the VR headset and having their limbs disposed in sleeves of the rehabilitation apparatus of FIG. 1;

FIG. 3 is a perspective view of legs of the patient viewed in reality and the legs of the patient viewed in virtual reality by the patient on the VR headset;

FIG. 4 is a perspective view of one of the legs of the patient held stationary in reality and being viewed on the VR headset by the patient as moving in virtual reality;

FIG. 5 is a flow chart depicting a method of using the rehabilitation apparatus and VR headset of FIG. 1 to perform rehabilitation on a patient; and

FIG. 6 is a perspective view of the legs of the patient viewed both in reality and virtual reality as stationary and a virtual leg displayed on the VR headset as moving.

### DETAILED DESCRIPTION

Embodiments of the presently disclosed methods of performing rehabilitation using VR and/or AR are described in detail with reference to the drawings, in which like reference numerals designate identical or corresponding elements in each of the several views.

The present disclosure provides methods of rehabilitating a patient with physiological and/or psychological disabilities that limit or disable the patient from performing certain motor functions, such as, for example, a basic movement of one or more limbs. The methods effectuate the activation of and opening of proprioceptive-neural-motor muscular pathways through a safe, natural, and organic process which implements VR and AR technologies in combination with contra-lateral and cross education training. The instant methods will assist a patient in regaining or newly-acquiring an ability to perform motor functions that were previously limited or impossible.

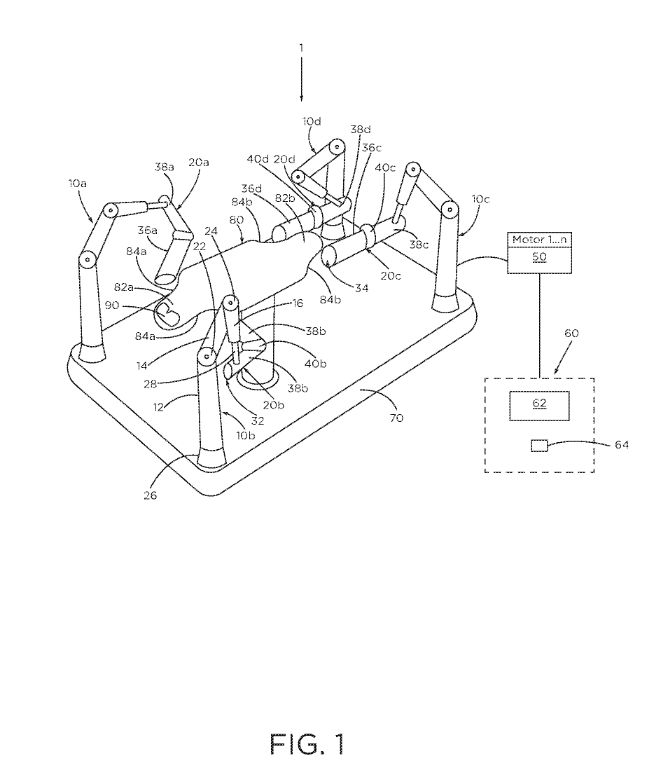

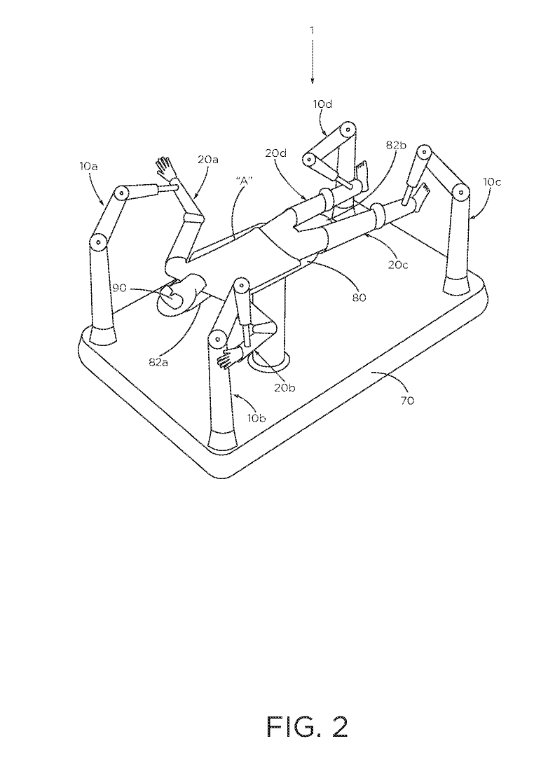

Referring initially to FIGS. 1 and 2, illustrated is a robotic rehabilitation apparatus, generally designated by reference numeral 1, for rehabilitating a patient by opening and activating existing, unused proprioceptive-neuro-motor muscular neural pathways in the brain, as will be described in detail herein. For a detailed description of an exemplary robotic rehabilitation apparatus, reference may be made to U.S. patent application Ser. No. 14/689,759 (now U.S. Patent Application Publication No. 2016/0302989), filed on Apr. 17, 2015, the entire contents of which being incorporated by reference herein.

It is contemplated that the robotic rehabilitation apparatus 1 may have applications in various fields. For example, in some embodiments, the apparatus 1 may be used in the medical field to treat various cognitive or neurological dysfunctions and various diseases of the mind, such as, for example, dementia, Alzheimer's disease, Parkinson's disease, brain trauma, brain damage associated with stroke victims, memory loss, attention deficit disorder, obsessive compulsive disorder, autism, or the like.

Robotic rehabilitation apparatus 1 generally includes a plurality of robotic arms 10a, 10b, 10c, 10d and a plurality of fastening members, such as, for example, sleeves 20a, 20b, 20c, 20d operably coupled to robotic arms 10a-d, respectively. As will be described in detail herein, robotic arms 10a-d are configured to move sleeves 20a-d, which have a patient's limbs associated therewith, in a discrete direction from one another and at a discrete speed from one another. Each of the robotic arms 10a-d may be composed of a plurality of segments 12, 14, 16, which are connected through joints 22, 24 such that robotic arms 10a-d have a plurality of degrees of freedom to move in a variety of directions. Movement of each segment 12, 14, 16 of robotic arms 2, 3 relative to one another may be driven by electric drives (not shown) that are connected to a control device 50, as will be described in greater detail below. Robotic arms 10a-d have a proximal end 26 supported on a base or platform 70, and a distal end 28. Proximal end 26 may be rotatable relative to platform 70. Distal end 28 of each robotic arm 10a-d may be configured to be selectively extendable and retractable along a longitudinal axis defined by distal end 28.

Distal end 28 of each robotic arm 10a-d has a respective sleeve 20a-d operably coupled thereto. Each sleeve 20a-d is moved independently from one another at a different speed or rate and in a different direction. Sleeves 20a-d are configured for receiving a limb of a patient. For example, a first pair of sleeves 20a, 20b that are associated with robotic arms 10a, 20b define a passageway 32 therethrough configured for receipt and retention of at least a portion of a pair of arms of a patient. A second pair of sleeves 20c, 20d that are associated with respective robotic arms 10c, 10d define a passageway 34 therethrough configured for receipt and retention of at least a portion of a pair of legs of the patient. As such, upon strapping a patient to robotic sports apparatus 1, both the arms and legs of the patient are retained within a corresponding sleeve 20a-d to be moved by robotic arms 10a-d in a variety of directions and at a variety of speeds. In some embodiments, one or more sleeves 20a-d may be configured for receipt and retention of various body parts of a patient, for example, hands, fingers, toes, feet, head, torso, etc.

Each sleeve 20a-d is composed of first and second segments 36a-d, 38a-d movably coupled to one another via a joint 40a-d. First segments 36a, 36b of the first pair of sleeves 20a, 20b is configured for receipt of an upper portion of a patient's arms, and second segments 38a, 38b of the first pair of sleeves 20a, 20b are configured for receipt of a lower portion of the patient's arms. Further, first segments 36c, 36d of the second pair of sleeves 20c, 20d are configured for receipt of an upper portion of a patient's legs, and second segments 38c, 38d of the second pair of sleeves 20c, 20d are configured for receipt of a lower portion of the patient's legs. In some embodiments, each robotic arm 10a-d may include one or more branches (i.e., distal ends 28) that each attach to a different segment of the associated sleeve for selectively moving the associated segment.

It is contemplated that sleeves 20a-d may be composed of only one segment without a joint. It is further contemplated that sleeves 20a-d may include more than two segments and more than one joint and may be flexible or rigid. In some embodiments, sleeves 20a-d may include a variety of fastening members to fasten and/or tighten sleeves 20a-d to the respective limb, for example, straps, buckles, hook and loop fasteners, adhesives, or the like.

Robotic rehabilitation apparatus 1 may include a control device 50 and an operating console 60 coupled with control device 50. Control device 50 may control a plurality of motors, e.g., motors (Motor 1 . . . n), with each motor configured to drive the independent movement of robotic arms 20a-d to effect movement of sleeves 20a-d in a plurality of directions and at a plurality of speeds. Operating console 60 includes a display device 62, which is set up in particular to display two or three-dimensional images; and a manual input device 64 by means of which a person (not shown) is able to input information into control device 50 for programming the direction and speed of movement of robotic arms 10a-d. Control device 50 (e.g., a computer) is set up to activate the drives (not shown) or robotic arms 10a-d, in particular by means of a computer program, in such a way that robotic arms 10a-d, and the attached sleeves 20a-d execute a desired movement according to a movement defined by means of manual input device 64.

Alternately, control device 50 may be pre-programmed to move robotic arms 10a-d at a pre-selected speed and in a pre-selected direction by having the pre-programmed movements stored in a memory (not shown) of control device 50. The memory may have a plurality of stored, unique pre-programmed movements of robotic arms 10a-d that are each tailored for a particular person. For example, one of the stored pre-programmed movements of robotic arms 10a-d may be tailored to treat a particular cognitive dysfunction, to rehabilitate a particular type of injury, or to improve or maintain the motor skills of a patient.

Robotic rehabilitation apparatus 1 further includes a platform or base 70 and a table 80. Platform 70 supports the proximal end 26 of each robotic arm 10a-d and table 80 thereon. In some embodiments, robotic arms 10a-d may be suspended from a ceiling or a gantry that extends over table 80. Table 80 is configured for supporting a patient thereon. Table 80 has a generally elongated configuration having a proximal end 82a and a distal end 82b. Proximal end 82a is configured for supporting an upper portion of a patient's body and distal end 82b is configured for supporting a lower portion of a patient's body. Proximal end 82a of table 80 has a pair of arcuate cutouts 84a therein that are designed to allow for a greater freedom of movement of arms of a patient lying on table 80. Distal end 82b of table 80 has a pair of arcuate cutouts 84b therein that are designed to allow for a greater freedom of movement of legs of a patient lying on table 80. In some embodiments, cutouts 84a, 84b may assume a variety of shapes, such as, for example, squared, triangular, or the like.

Robotic rehabilitation apparatus 1 moves sleeves 20a-d independently from one another at a discreet speed and in a discrete direction relative to one another. For example, sleeve 20a may move one arm of patient at a first speed (e.g., 0.1 m/s) and in a circular motion in a coronal plane of patient; sleeve 20b may move the other arm of patient at a second speed (e.g., 0.2 m/s) and in a circular motion in a transverse plane of patient; sleeve 20c may move one leg of patient at a third speed (e.g., 0.3 m/s) in an up and down motion parallel to a sagittal plane of patient; and sleeve 20d may move the other leg of patient at a fourth speed (e.g., 0.4 m/s) in a counter-clockwise direction. As such, no limb will be moving at the same speed or in the same direction as any other limb. It is contemplated that limbs and other body parts of patient may be moved in a plurality of directions other than those mentioned above. It is further contemplated that the speed and direction of sleeves 20a-d may change randomly during the same treatment.

As can be appreciated, the randomized movement of sleeves 20a-d and ultimately of limbs of patient cannot be accomplished by a person without the assistance of robotic rehabilitation apparatus 1. This randomized limb movement made possible by robotic rehabilitation apparatus 1 opens unused neural pathways in the brain to, inter alia, provide greater level of precision in lower limb movement with accompanying heightened awareness in reflex and balance.

Robotic rehabilitation apparatus 1 may further include a headset 90 equipped with VR and/or AR technology. The headset 90 is a head-mounted display that presents media to a wearer. For example, the media presented by the VR headset 90 includes one or more images, video, audio, or some combination thereof. For a detailed description of an exemplary headset, reference may be made to U.S. patent application Ser. No. 14/601,572 (now U.S. Pat. No. 9,472,025), filed on Jan. 21, 2015, the entire contents of which are incorporated by reference herein.

Movement sensors or trackers (not shown), such as, for example, a three-dimensional reconstruction device may be used to capture the movement of patient's limbs. The trackers are in communication with the headset 90 such that the trackers transmit sensed data representative of the movement of patient's limbs to the headset 90, which then displays the movement for the patient to view in virtual reality. In some embodiments, a video camera (not shown) may be attached to the apparatus 1 or the patient and be directed at the limb being rehabilitated to record and transmit the data to the headset 90, which displays the movement of the limb for the patient's viewing in real time.

In one method of rehabilitation provided by the present disclosure, a patient afflicted with a disease or disability that affects one or more motor functions (e.g., the ability for the patient to move their legs “LL,” “RL” due to a leg injury or a stroke) is positioned on table 80 with his or her arms inserted within sleeves 20a, 20b of robotic rehabilitation apparatus 1 and his or her legs “LL,” “RL” inserted within sleeves 20c, 20d of robotic sports apparatus 1. In some methods, when only one limb of the patient requires rehabilitation, only that particular limb will be inserted within one of the sleeves 20a-d. The VR headset 90 is placed on the head of the patient so that the patient can view a virtual video generated by the headset 90. In other embodiments, instead of using apparatus 1 to move the subject limb(s) of the patient, a clinician, such as a rehabilitation specialist, may manually move the subject limb(s) of the patient.

Depending on the type of disability to be treated (e.g., loss of or reduced motor function in a limb), a particular operation of robotic rehabilitation apparatus 1 or a particular stored, pre-programmed movement of robotic arms 10a-d will be selected. Upon selecting the particular operation that is tailored for the patient, the motors of robotic arms 10a-d will be activated to effect movement of robotic arms 10a-d and associated sleeves 20a-d. For example, in the illustrated embodiment, robotic arms 10c, 10d and associated sleeves 20c, 20d will be moved to effect movement of the left and right legs “LL,” “RL” of the patient, respectively.

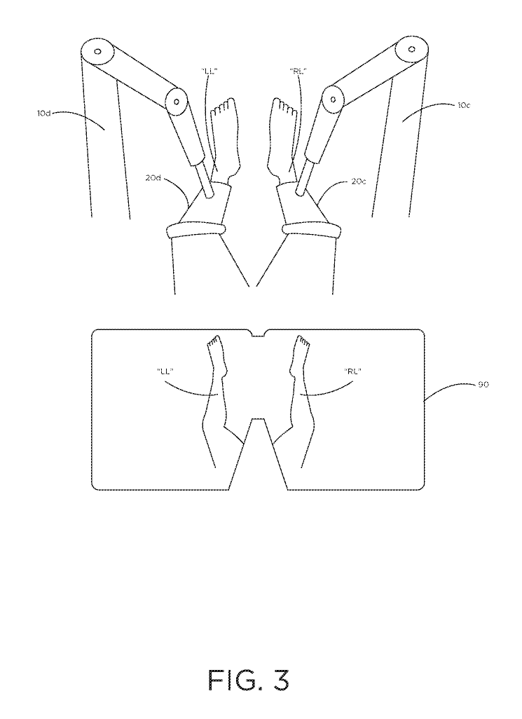

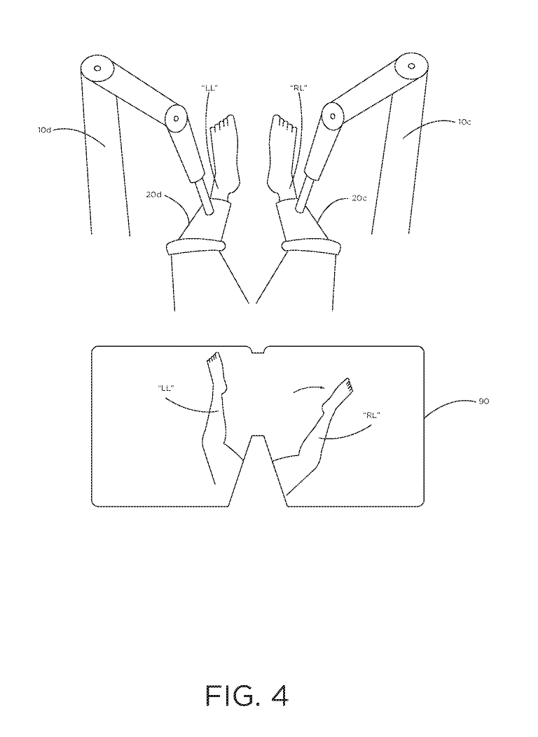

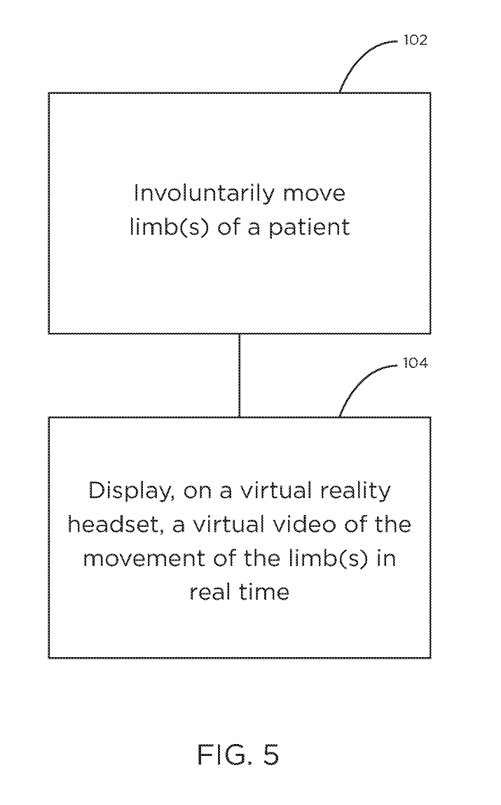

With reference to FIGS. 3-5, in step 102 of the disclosed method, upon connecting patient's legs “LL,” “RL” to the respective sleeves 20c, 20d of apparatus 1, the robotic arms 10c, 10d are activated to effect a corresponding motion (e.g., circular) of first and second legs “LL,” “RL” of the patient at a particular speed. As the first and second legs “LL,” “RL” of the patient are being involuntarily moved by the apparatus 1, the movement sensors track the movement of the legs “LL,” “RL” in 3-dimensions. In step 104, the data representative of the movement of the patient's legs “LL,” “RL” is transmitted to the headset 90, which displays a virtual video of the first and second legs “LL,” “RL” on an electronic display of the headset 90 for the patient to view, in real time. The virtual video displays the legs “LL,” “RL” moving without showing the sleeves 20c, 20d or any component of the apparatus 1. As such, the patient views a virtual video of their legs “LL,” “RL” moving as if they are moving their legs “LL,” “RL” unassisted.

Viewing movement of one's legs, in virtual reality, as if they are being moved voluntarily or unassisted may open up new neural pathways in the brain. These new neural pathways may make it easier for the patient to move his or her legs without the assistance of apparatus 1. Another benefit of using virtual reality to view one's limbs during rehabilitation is that it may be unconformable, difficult, or even physically impossible for the patient to position themselves in a way to view in reality the particular limb or limbs being moved. Thus, the VR headset 90 allows the patient to view the rehabilitation process without having to strain themselves for viewing in reality.

An additional step in the rehabilitation procedure may include recording, by the headset 90, the virtually displayed movement of the first and second limbs “LL,” “RL.” With the virtually displayed movement of the first and second limbs “LL,” “RL” recorded, the patient may access the video and replay the rehabilitation session at any time and at any location. In particular, a patient may wear the headset 90 and play the recording of the virtually displayed movement of their legs “LL,” “RL” in the comfort of their home. While viewing the recording, the patient may attempt to voluntarily move their legs “LL,” “RL” to match the same path and speed at which their legs “LL,” “RL” are displayed as being moved in the virtual recording. In this way, while the patient may not be able to voluntarily move their legs “LL,” “RL” in the same manner as their legs “LL,” “RL” are displayed as being moved in the virtual recording, the patient's brain may be tricked into believing that they are. This “tricking” of the brain may open up new neural pathways that can be used by the brain when the patient attempts to move his or her legs “LL,” “RL.” Additionally, performing the rehabilitation session again reinforces or strengthens the neural pathways developed by the previous rehabilitation session.

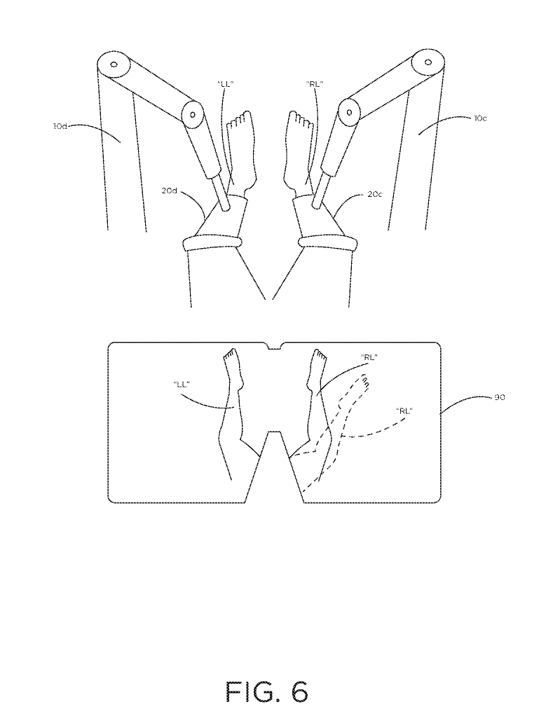

With reference to FIG. 6, as an alternative to displaying the patient's legs “LL,” “RL” moving in virtual reality, the patient's legs “LL,” “RL” may be shown to the patient as an augmented virtual video. In particular, the recording of the legs “LL,” “RL” may be overlaid onto a real video of the patient legs “LL,” “RL.” As such, the patient will see a video of their legs “LL,” “RL” in reality, which may remain stationary, and another video shown as an augmented virtual video of their legs “LL,” “RL” moving.

In another aspect of the present disclosure, a method of rehabilitating a patient with an injured limb (e.g., a leg) is provided. This method is to be used when the injured limb is in a non-weight bearing period in which immobilization and unregulated unweighting may affect the integrity of the musculature surround the knee joint. As such, the injured limb is immobilized during the rehabilitation procedure. This method includes passively or actively moving another limb or limbs (e.g., both arms and the non-injured leg) using any of the above-noted techniques. Concurrently with the movement of the limbs, the patient views said movement in virtual reality. While the injured leg is immobilized as the other limbs are being moved during this procedure, the injured limb appears to the patient as if it is actually being moved since the immobilized limb is shown as moving in virtual reality.

It has been found that visual confirmation of movement of a limb, albeit a limb that in reality is not moving, may trick the brain into thinking that the limb is really moving, thereby forming neural pathways that may be accessed after the limb exits the immobilization period. As such, the patient will be more likely to “hit the ground running” upon starting physical rehabilitation once the immobilization period ends by accessing the neural pathways developed during the virtual reality rehabilitation.

It will be understood that various modifications may be made to the embodiments and methods disclosed herein. Therefore, the above description should not be construed as limiting, but merely as exemplifications of various embodiments and methods. Those skilled in the art will envision other modifications within the scope and spirit of the claims appended thereto.

What is claimed is:

1. A method of performing rehabilitation, comprising:
moving a first limb of a patient; and
displaying, for viewing by the patient in virtual reality, the movement of the first limb of the patient as the first limb of the patient is being moved.

2. The method according to claim 1, wherein the first limb of the patient is being moved involuntarily.

3. The method according to claim 1, further comprising moving a second limb of the patient concurrently with movement of the first limb.

4. The method according to claim 3, further comprising displaying, for viewing by the patient in virtual reality, the movement of the second limb of the patient.

5. The method according to claim 3, wherein the first and second limbs are moved in at least one of a different direction or a different speed relative to one another.

6. The method according to claim 5, wherein the first and second limbs are moved in a different direction and a different speed relative to one another.

7. The method according to claim 1, further comprising:
recording the virtually displayed movement of the first limb; and
displaying, for viewing by the patient in virtual reality, the recorded virtually displayed movement of the first limb.

8. The method according to claim 7, wherein the recorded virtually displayed movement of the first limb is displayed while the patient attempts to voluntarily move the first limb.

9. The method according to claim 8, wherein the patient attempts to voluntarily move the first limb along a path and at a speed each matching the path and the speed of the virtually displayed movement of the first limb.

10. The method according to claim 1, further comprising:
recording the virtually displayed movement of the first limb; and
displaying, for viewing by the patient in augmented virtual reality, the recorded virtually displayed movement of the first limb.

11. The method according to claim 1, further comprising:
inserting the first limb and a second limb of the patient into a respective fastening member of a robotic rehabilitation apparatus, wherein each fastening member is operably coupled to a respective robotic arm of a plurality of robotic arms of the robotic rehabilitation apparatus; and
actuating the plurality of robotic arms to effect movement of the first and second limbs, wherein the first and second limbs are moved in at least one of a different direction or a different speed relative to one another.

12. The method according to claim 11, wherein the first and second limbs are moved in a different direction and a different speed relative to one another.

13. The method according to claim 11, further comprising positioning the patient on a table of the robotic rehabilitation apparatus.

14. The method according to claim 11, wherein the robotic rehabilitation apparatus includes a control device operably connected to the plurality of robotic arms for directing a selected movement of the plurality of robotic arms.

15. A method of performing rehabilitation, comprising:
moving at least one first limb of a plurality of limbs of a patient while immobilizing at least one second limb of the plurality of limbs of the patient; and
displaying, for viewing by the patient in virtual reality, movement of the at least one first limb of the patient and the immobilized at least one second limb of the patient.
